(19) United States
(12) Patent Application Publication
(10) Pub. No.: US 2017/0350671 A1
(43) Pub. Date: Dec. 7, 2017

(54) VEHICLE ANTENNA MAST CLEANING ROD CONVERSION SYSTEM FOR FIREARM CLEANING

(71) Applicant: JOSHUA C. LARUE, Liberty Hill, TX (US)

(72) Inventor: JOSHUA C. LARUE, Liberty Hill, TX (US)

(21) Appl. No.: 15/175,786

(22) Filed: Jun. 7, 2016

(51) Int. Cl. F41A 29/02; H01Q 1/36; H01Q 1/32

(52) U.S. Cl. CPC F41A 29/02; H01Q 1/3275; H01Q 1/36

(57) ABSTRACT

A vehicle radio antenna mast, temporarily removed from a vehicle, is converted for other use by employing one or more conversion members that connect other components, such as firearm bore cleaning apparatus, with the ends of the antenna mast. After being used for the alternative purpose the antenna mast is restored to its primary use as a vehicle antenna by removing the conversion members and connecting the mast with antenna mounting apparatus of the vehicle.

### BACKGROUND OF THE INVENTION

### Field of the Invention

The present invention relates generally to cleaning equipment that is conventionally used for cleaning and lubricating the bore of firearms such as rifles and shotguns. More particularly, the present invention concerns antenna mounts and antenna masts that permit the mast and spring mechanism of vehicle antennas to be temporarily converted simply and efficiently for use as a firearm cleaning rod and after cleaning rod use is then simply and easily restored for use as a vehicle antenna. Even more specifically, this invention concerns conversion components that are employed to convert a vehicle antenna mast for use as a firearm cleaning rod.

### Description of the Prior Art

Many different types of firearm cleaning kits and devices have been provided over a long period of time to enable firearm users to clean their firearms after use or periodically during periods of non-use. In the case of long barreled guns such as shotguns and rifles, it is generally considered preferable to use a long non-jointed cleaning rod having a freely rotatable handle at the rear end and having a fitting at the forward end for support of bore cleaning and lubricating attachments such as metal of polymer brushes and cleaning and lubricating patches. However, it is well known that long, non-jointed cleaning rods are cumbersome to store and transport, and thus are typically not available for use in the field. For that reason, most gun cleaning kits have cleaning rods that are composed of a number of thread connected rod sections.

Jointed cleaning rods are problematic as well, because the thread connections of the rod joints are typically subjected to considerable wear and damage during use, especially if they are composed of a soft and lightweight metal such as aluminum or a soft metal such as brass. It is desirable, therefore, to provide a cleaning rod system having a rod-like mast that is employed on a daily basis as an antenna mast for a vehicle, and is adaptable through the use of conversion attachments, for use as a bore cleaning rod for long barreled firearms such as rifles, shotguns and the like. Serving primarily as an antenna mast on a vehicle, the thin spring steel mast is readily available for use as the basic component of a gun bore cleaning rod in virtually any field conditions where a vehicle, such as a pickup truck or SUV is employed. After use a gun bore cleaning and lubricating rod, the antenna mast is readily restored to its use as a vehicle mounted antenna by removing the handle and bore cleaning implements and by again connection the antenna mast to its vehicle mount.

### SUMMARY OF THE INVENTION

It is a principal feature of the present invention to provide novel adapter components that facilitate the use of an elongate antenna mast as a component of a bore cleaning rod assembly for use in cleaning and lubricating the bore of a firearm barrel;

It is another feature of the present invention to provide a novel firearm cleaning kit having various attachments for cleaning and lubricating firearms and incorporating conversion attachments for converting a conventional vehicle radio antenna mast for use as a gun cleaning rod and, following gun cleaning use, restoring the mast for use as a radio antenna.

Briefly, the various objects and features of the present invention are realized through the provision of a small compact and easily transportable and storable gun cleaning kit for use in accordance with the teachings of the present invention. The gun cleaning kit incorporates various attachments for cleaning and lubricating the bore or a long gun, such as a rifle or shotgun. According to the present invention, the gun cleaning kit also incorporates various conversion attachments for converting the conventional small diameter typically spring steel radio antenna mast for use as the elongate rod component of a gun cleaning rod for long guns, such as rifles and shotguns. After using the converted cleaning rod assembly for gun cleaning, the cleaning rod assembly is disassembled, by removing the conversion attachments. The antenna mast component is then reassembled to the antenna mount of a vehicle for continued use as a radio antenna.

While the present invention generally describes using a vehicle antenna mast and mount as a firearm bore cleaning rod, numerous other uses of a vehicle antenna mast are envisioned. For example, a fishing rod tip implement structure may be adapted for mounting to an antenna mast, thereby converting the mast to a simple fishing rod. Various other types of tip and handle implements may be provided in the portable kit as well. For example an antenna mast may be converted in similar manner for use as a vehicle unlocking device, which is typically referred to as a “slim jim” or for use as a lenghty grappling tool. Conversion members or devices are contained in readily transportable kit form and can be simply and efficiently employed via the use of simple tools to achieve conversion of a radio antenna mast for other uses in field conditions where vehicle service tools are not readily available.

Many heavy duty radio antenna systems have been developed, such as for commercial trucks, that employ helical springs in association with the vehicle mounts. The helical springs, which are typically tapered to each spring end, permit the antenna masts to be pushed over when struck by an object, thus preventing any antenna damage. These helical springs can be effectively employed as a handgrip or rod handle when the antenna mast is to be employed as a firearm bore cleaning rod. Conversion members may be provided in the form of antenna mast conversion kits that can be easily and efficiently transported in a firearm servicing container and, when needed, can be used to convert a radio antenna mast for use as a bore cleaning rod, fishing rod, slim-jim or other suitable tool or device for use particularly in a remove environment where other tools are typically not readily available.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an elevation view having parts thereof broken away and showing the lower portion of a vehicle radio antenna representing the prior art and being mounted to a vehicle;

FIG. 2 is a top plan view showing a gun cleaning rod handle being mounted to the base fitting of a radio antenna mast by means of a mounting adapter;

FIG. 3 is a top plan view showing assembly of the components of FIG. 2 to define a bore cleaning rod for firearm cleaning;

FIG. 4 is a partial side elevation view having parts thereof shown in section and having an end fitting attached to an end portion of an antenna mast and forming a cleaning and lubricating patch holder for gun bore cleaning;

FIG. 5 is a partial side elevation view showing a wire brush type gun bore cleaning member being mounted to the end fitting member of FIG. 4 for wire brush cleaning of the bore of a gun barrel;

FIG. 6 is a partial side elevation view showing a fishing rod tip member being mounted to the end fitting member of FIG. 4 for conversion of an antenna mast for use as a fishing rod;

FIG. 7 is a partial section view showing the upper portion of a conventional vehicle radio antenna mast representing the prior art;

FIG. 8 is a partial section view showing an antenna mast having a mast tip member representing a second conversion member mounted thereto and further showing an implement connected with a threaded mast tip in preparation for use of the rod assembly to do mechanical work; and

FIG. 9 is a side elevation view showing the handle structure of a converted firearm bore cleaning rod being defined by a helical tapered spring such as is typically employed with a radio antenna mount to provide additional protection against antenna damage in the event the antenna should be caused to hit an object during handling of the vehicle.

### DETAILED DESCRIPTION OF PREFERRED EMBODIMENT

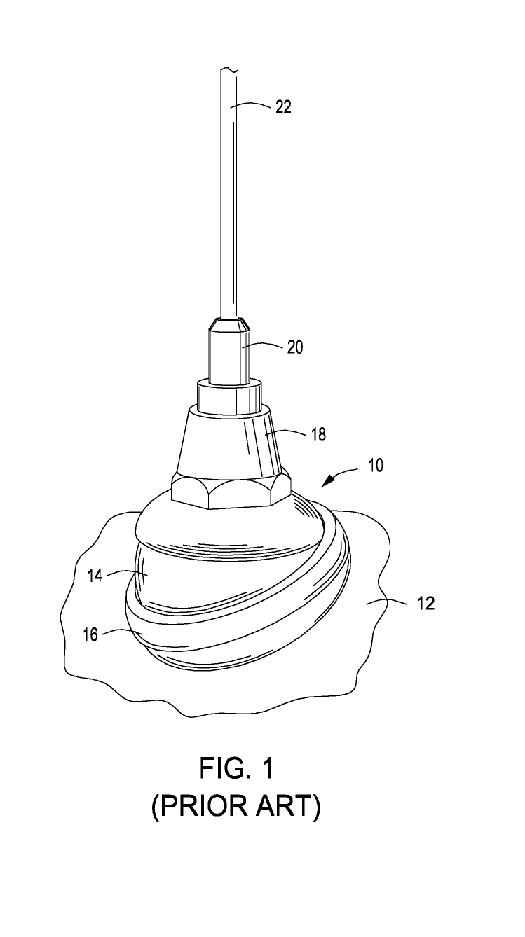

Referring now to the drawings and first to FIG. 1, a radio antenna mechanism representing the prior art is shown generally at 10 and is secured to a vehicle structure 12 by an antenna mount having a mount base 14. The mount base is weather sealed to a sheet metal panel vehicle structure by means of a weather seal grommet 16 that is composed of an elastomer or polymer material. The antenna mechanism 10 has a bolt or other attachment defining a threaded section that projects upwardly and receives an internally threaded mount connector 18 that secures the base portion 20 of an antenna mast 22 to the antenna mount.

The antenna mast 22 is typically in the form of a thin rod-like structure of circular cross-section that is composed of spring steel or any other suitable material that will not readily become permanently bent and deformed by the force of wind resistance as the vehicle is being driven or when impacted by other objects. The thin antenna mast is intended to yield to a curved configuration by wind resistance when the vehicle is being moved. When the vehicle is passed through a car wash mechanism, personnel will typically unthread the internally threaded mount connector 18 from the upstanding externally threaded mounting post of the antenna mount and remove it to ensure that it will not be damaged by the rotating brushes of the car wash mechanism. Thus, an antenna mast is often disengaged from its vehicle mount and if it should become damaged it is easily replaced. Replacement antenna masts are typically accompanied by a number of threaded mount connectors that are made to fit the thread arrangement of various brands of vehicles.

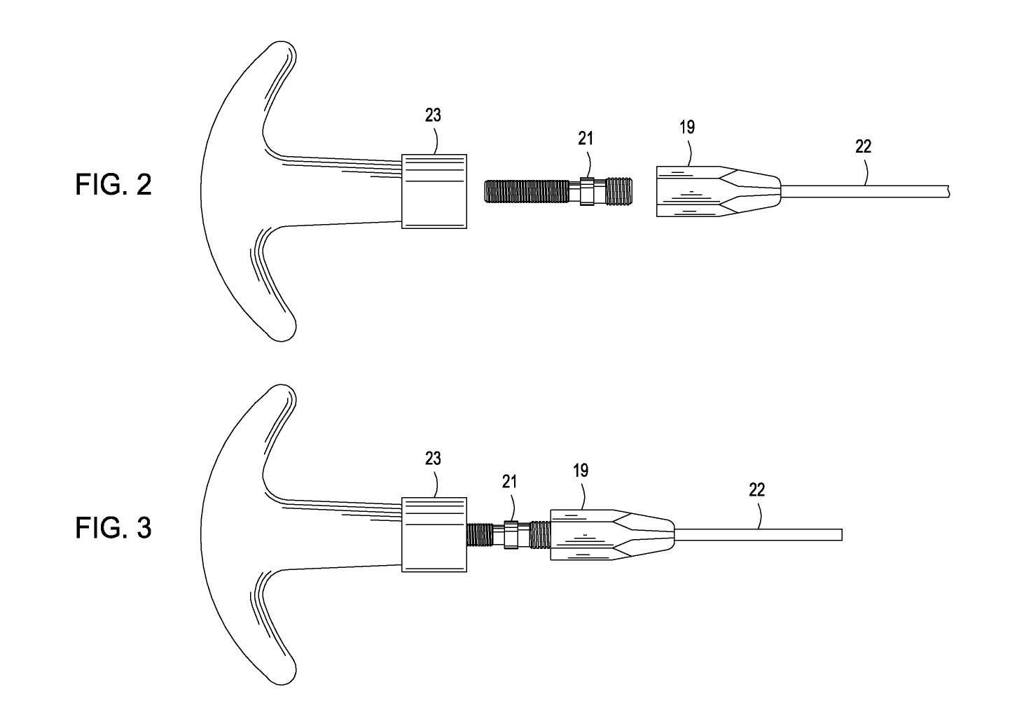

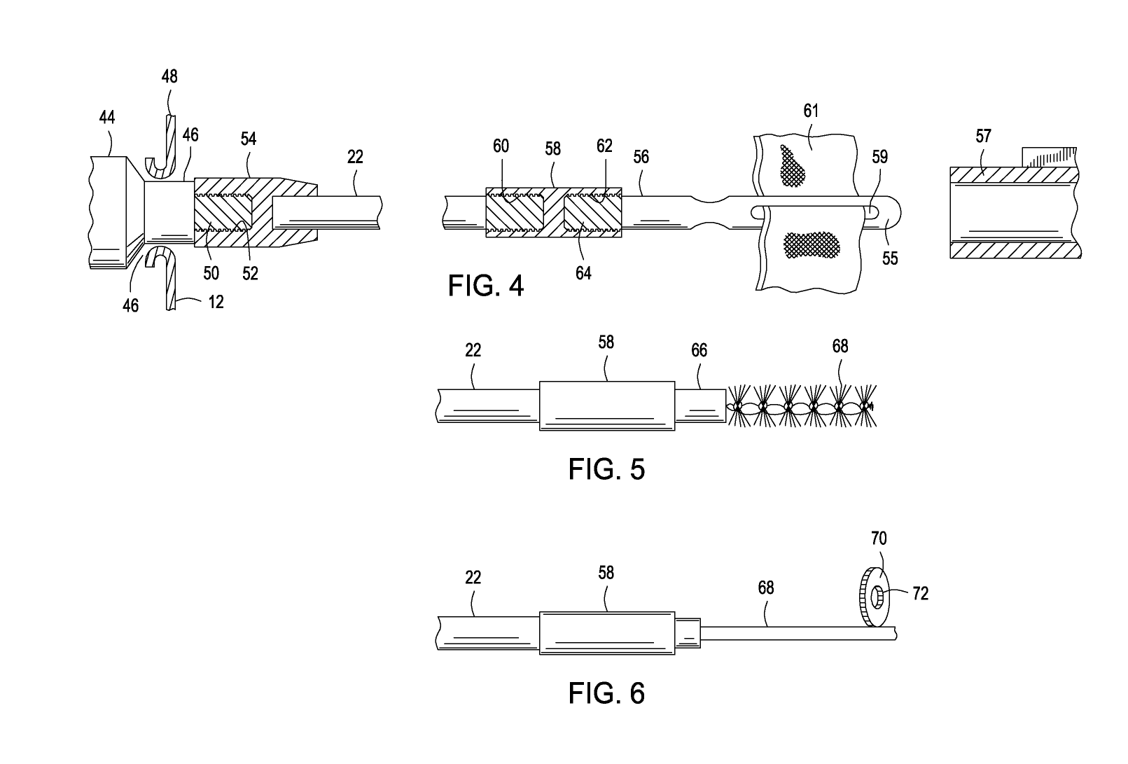

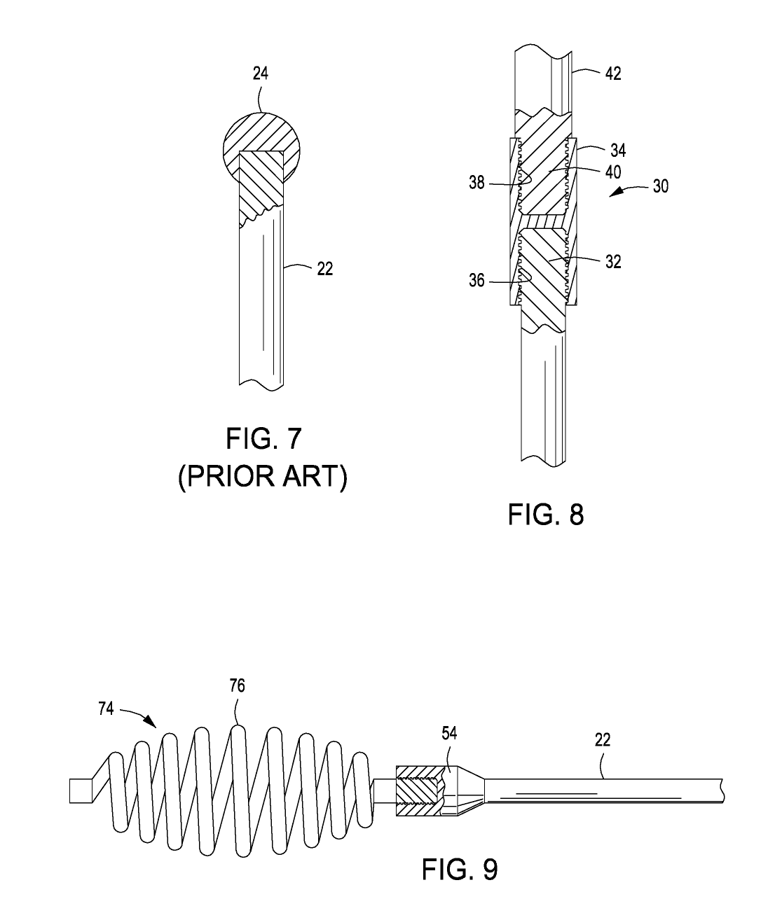

As mentioned above, the spirit and scope of the present invention generally concerns the method and apparatus for conversion of vehicle antenna masts to serve other uses on a temporary basis, thus taking advantage of the fact that the antenna masts are virtually always present and readily available, being a component of a vehicle that is used for travel particularly to remote environments where outdoor activities take place. According to the present invention, as shown in FIGS. 2 and 3, the internally threaded mount connector 18, after having been removed from the antenna mount of the vehicle, can be threadedly connected with an externally threaded conversion member, permitting a handle device, such as a cleaning rod handle to be connected with the antenna mast. This feature permits the antenna mast to serve an elongate non-jointed component of a tool or device having a different purpose, such as serving as a non-jointed cleaning rod for firearm bore cleaning. This feature is accomplished as shown in FIGS. 2 and 3 by using a threaded conversion member for connecting a cleaning rod handle 23 to the internally threaded mount connector 19 that is located at a first or lower end of the antenna mast 22 by means of a first conversion member 21 and by connecting a firearm bore cleaning and lubricating attachment 56 to a second or upper end of the vehicle antenna mast by means of a second conversion member 58 that is connected to or mounted at the second end of the vehicle antenna mast 22. Typically a generally spherical tip member 24 of a prior art antenna is secured to the antenna mast 22 by means of soldering or braising as shown in FIG. 7. The spherical tip is removed from the antenna mast and the upper end of the mast is externally threaded, as shown in FIGS. 4 and 8, thus enabling a second conversion member shown generally at 30 to be temporarily or permanently mounted to the second end 32 of the antenna mast 22 as desired.

As shown in FIG. 8, the upper end 32 of the antenna mast 22 can be externally threaded, as shown, for attachment of a spherical or tubular antenna tip 34, thus providing for temporary removal of the antenna tip. The tubular tip member 34 represents the second conversion member 40 and is shown in FIG. 8 as being provided with an internally threaded section 36 which receives the upper externally threaded end 32 of the spring steel antenna mast 22. If desired, the thread connection 32/36 may be eliminated and the tubular tip may be soldered or braised to the upper end 32 of the antenna mast to provide for permanent mounting of the tip member 34 to the vehicle antenna mast and simplify conversion of the mast. The tubular tip member 34 is shown to be provided with an internally threaded section 38 that receives the externally threaded section 40 of an attachment or implement member 42 that is designed for doing desired work. When the antenna mast is employed as a component of a firearm cleaning rod or is intended for other use, an externally threaded shaft 40 of a gun cleaning implement 42 is threaded into the internally threaded section 38 of the tubular tip member 34. The implement 42 may have any suitable design or character for accomplishment of intended work, such as gun bore cleaning for example.

With reference to FIGS. 4-6 a vehicle antenna mount representing the prior art is shown at 44 having a portion 46 that projects upwardly through an opening 46 in the sheet metal structure 48 of a vehicle. The mount section 46 has an externally threaded mounting post 50 that is received within the internally threaded portion 52 of an antenna mount connector 54 that provides support for the vehicle antenna mast 22.

In the performance of the present invention the antenna mount connector 54 is unthreaded from the externally threaded mounting post 50 and the first conversion member 21 of FIG. 2 is threaded into the threaded receptacle 52. The handle 23 is then connected in threaded engagement with the lower threaded end of the conversion member 21. To provide for mounting of an implement to the upper end of the antenna mast 22 as shown in FIG. 4, a second conversion member 58 is mounted to the antenna mast. For example, a firearm bore cleaning and lubricating patch retainer 56 shown in FIG. 4 has a blade-like tip 55 of a dimension to pass easily through the bore of a firearm barrel 57. The blade-like tip 55 defines a longitudinal slot 59 within which a replaceable bore cleaning patch 61 is positioned to enable the patch to be forced through the bore for cleaning away gunpowder residue, metal fouling, etc. The cleaning and lubricating patch 61 may be saturated with a cleaning fluid or a lubricant for cleaning and lubricating the barrel bore.

The character of mounting of the second conversion member 58 can be temporary, such as by means of a releasable threaded connection as shown or by means of a soldered, braised or bonded connection to provide for its permanent mounting. When the antenna is again installed on the vehicle antenna mount, a replacement tip member of spherical or other desired configuration may be installed, such as by threading, to provide a substantially weather-resistant antenna tip. The second conversion member 58 is of tubular configuration having an internally threaded receptacle 60 within which the upper end of the antenna mast 22 is secured. An upwardly facing internally threaded receptacle 62 is defined by the tubular second conversion member within which the externally threaded section 64 of the slotted bore cleaning and lubricating patch retainer 56 is received.

FIG. 5 is a partial side elevation view showing an implement 66 having a wire brush of generally cylindrical geometry that is passed through the bore of a firearm for cleaning away gunpowder residue and other debris that might cause fouling of the bore.

FIG. 6 is another partial side elevation view showing an implement having a fishing rod tip 68 supporting a circular grommet 70 that defines a central hole 72 through which fishing line will pass. This feature enables a vehicle antenna mast to be employed as a component of a fishing rod.

FIG. 9 is a side elevation view showing a rod handle structure 74 that is defined by a helical spring 76 having tapered ends. The helical spring is typically mounted between the antenna mount and the antenna mast to provide additional protection against damage to the mast in the event the mast should contact an object during travel of the vehicle to which it is mounted.

### OPERATION

Typically the user of the present invention will travel by vehicle, typically a truck or SUV, to a desired location, particularly a remote location in the field where a task is to be carried out. To the vehicle is mounted a radio antenna such as is shown in FIG. 1. When the task to be accomplished involves the use of firearms, such as rifles or shotguns, when shooting activities have been completed, many firearm users will want to clean and lubricate the bore of the firearm as soon as practicable to remove gunpowder fouling and other debris from the bore and minimize the potential for chemical deterioration of the barrel material at the bore. Typically the firearm user will have in possession a gun cleaning kit having a number of different gun and bore cleaning implements that are connected with a gun cleaning rod. To minimize the size of the gun cleaning kit, the cleaning rod will virtually always be of the jointed variety, requiring the user to assemble the cleaning rod and then selectively assemble desired bore cleaning and lubricating implements to the cleaning rod. Though jointed cleaning rods are typically used, most firearm users prefer the use of non-jointed cleaning rods because of the inherent weakness and instability of the threaded cleaning rod joints. However, as mentioned above, non-jointed bore cleaning rods are seldom carried to the field because of the difficulty of transporting and storing them at times when they are not being used.

According to the present invention, the presence of a vehicle radio antenna and conversion members to convert it for use as a bore cleaning rod or to form other useful tools, serves as a solution to the problems that arise when using jointed gun cleaning rods. By using a simple tool, such as an adjustable wrench, the antenna is unthreaded from the upstanding threaded post of the antenna mount. A conversion member is selected which has an external thread at a first end that fits the internal thread of the mount connector 19 of the antenna mast and an external thread at a second end that is received by an internal thread of the mount connector 19. A second conversion member is mounted either temporarily or permanently to the upper or forward end of the antenna mast is internally threaded for connection of an implement, such as a slotted holder for bore cleaning patches or a wire bore cleaning brush. The antenna mast serves temporarily as a cleaning rod and is reciprocated within the barrel bore to accomplish cleaning and/or lubrication. The implement that is mounted to the antenna mast by the conversion member may have a variety of different forms to permit the antenna mast be employed as a component of a tool to accomplish a desired task.

The antenna mast is restored to its original purpose simply by unthreading the first conversion member from the handle and the antenna mast and unthreading and removing the implement from the second conversion member. The second conversion member may be left in place on the upper end of the antenna mast to enable its future use, or may be removed and replaced by a threaded antenna end that may be spherical or of any other desired configuration. The conversion members will typically be placed in the firearm cleaning kit for future use as desired. The vehicle radio antenna is then restored for use by disassembling the converter members from the antenna mast and then connecting the antenna mast to the antenna mount by threading the mount connector member with the upstanding threaded post of the mount.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A method for converting a vehicle antenna mast for other temporary use, comprising:
removing a vehicle antenna mast from an antenna mount of a vehicle;
connecting a conversion member to one end of the antenna mast;
assembling a device to said conversion member to define an implement that is suitable for an alternative purpose;
disassembling said conversion member from said vehicle antenna mast; and
mounting said vehicle antenna mast to the antenna mount of the vehicle.

2. The method of claim 1, wherein the antenna mount of the vehicle has a thread connection and the vehicle antenna mast has a threaded connector matching said thread connection permitting threaded connection of said antenna mast to said antenna mount, said method comprising:
after unthreading and removing said vehicle antenna mast from said antenna mount establishing threaded connection of said conversion member with said thread connector; and
establishing threaded connection of said conversion member with a thread connection of an implement accomplishing a specific activity.

3. The method of claim 2, wherein said conversion member is an elongate member having first and second threaded ends and said device is a handle member, said method comprising:
threadedly connecting said first threaded end of said conversion member with said handle member; and
threadedly connecting said second threaded end of said conversion member with said thread connection of said antenna mast.

4. Apparatus for temporarily converting an elongate vehicle radio antenna mast to a tool or implement for accomplishing a specific task, comprising:
an elongate vehicle radio antenna mast having first and second ends and having a mount connector member being releasably received in threaded assembly with a radio antenna mount of a vehicle;
a handle member adapted to be manually manipulated by a person for accomplishing an intended task;
a first conversion member extending from said handle member and having threaded connection with said mount connector member of said vehicle antenna mast;
a second conversion member being mounted to said second end of said vehicle antenna mast and defining an implement mount receptacle;
an implement having a connection portion thereof received by said implement mount receptacle and being positioned to accomplish work when said elongate vehicle radio antenna mast is manipulated.

5. The apparatus of claim 4, comprising:
said first conversion member being defined by a shaft having a first external thread at a first end thereof in threaded connection with said handle and a second external thread at a second end thereof being in threaded connection with said mount connector member of said antenna mast.

6. The apparatus of claim 4, comprising:
said implement having a geometry for an intended task and having a connecting end for mounting thereof; and
said second conversion member being of tubular configuration and having a first receptacle receiving said second end of said antenna mast and having a second receptacle receiving said connecting end of said implement.

7. The apparatus of claim 6, comprising:
said first and second receptacles being internally threaded; and
said implement and said second end of said antenna mast being externally threaded and having threaded engagement with said first and second receptacles of said second conversion member.

8. The apparatus of claim 4, comprising:
said handle member being in the form of a helical spring member having tapered ends and being of sufficient size to be comfortably received by a hand of the user.

9. Apparatus for temporarily converting an elongate vehicle radio antenna mast to serve as a component of a tool or implement for accomplishing a specific task, comprising:
an elongate vehicle radio antenna mast having first and second ends and having a mount connector member being releasably received in threaded assembly with a radio antenna mount of a vehicle;
a handle member adapted to be manually manipulated by a person for accomplishing an intended task;
a first conversion member having threaded connection with said handle member and having threaded connection with said mount connector member of said vehicle antenna mast and securing said handle member in assembly with said first end of said elongate vehicle radio antenna;
a second conversion member being threadedly connected with said second end of said vehicle antenna mast and defining an implement mount receptacle; and
an implement having a connection portion thereof received by said implement mount receptacle and being positioned to accomplish work when said elongate vehicle radio antenna mast is manipulated.

10. The apparatus of claim 9, comprising:
said first conversion member being defined by a shaft having a first external thread at a first end thereof in threaded connection with said handle and a second external thread at a second end thereof being in threaded connection with said mount connector member of said antenna mast.

11. The apparatus of claim 9, comprising:
said implement having a geometry for an intended task and having a connecting end for mounting thereof; and
said second conversion member being of tubular configuration and having a first receptacle receiving said second end of said antenna mast and having a second receptacle receiving said connecting end of said implement.

12. The apparatus of claim 11, comprising:
said first and second receptacles being internally threaded; and
said implement and said second end of said antenna mast being externally threaded and having threaded engagement with said first and second receptacles of said second conversion member.
